(19) United States
(12) Patent Application Publication
(10) Pub. No.: US 2024/0072508 A1
(43) Pub. Date: Feb. 29, 2024

(54) LASER POWER CONTROL

(71) Applicant: Kwik Lok Corporation, Union Gap, WA (US)

(72) Inventor: Andrew Leonard Roy, Yakima, WA (US)

(21) Appl. No.: 18/455,495

(22) Filed: Aug. 24, 2023

Related U.S. Application Data
(60) Provisional application No. 63/401,998, filed on Aug. 29, 2022.

(51) Int. Cl. H01S 3/104; H01S 3/10; H01S 3/223

(52) U.S. Cl. CPC H01S 3/104; H01S 3/10069; H01S 3/2232

(57) ABSTRACT

The disclosure generally relates to laser power control. An example method includes obtaining data regarding laser output and input applicable to a CO2 laser generating system, and using the obtained data to generate an estimated correspondence relationship between input parameter and laser power output. Responsive to an indication of a target power output of laser, configuring the input parameter to control the CO2 laser generating system in accordance with the estimated correspondence relationship, thereby causing a resultant laser output.

### BACKGROUND

### Technical Field

The present disclosure relates generally to laser power control, and more specifically to CO2 laser output control for laser-based stitching, sealing, or other operations.

### Description of the Related Art

The word “laser” is an acronym for “light amplification by stimulated emission of radiation.” A laser generating system or device (generally referred to as laser) can emit light through a process of optical amplification based on the stimulated emission of electromagnetic radiation.

Lasers can be used in optical disc drives, laser printers, barcode scanners, DNA sequencing instruments, fiber-optic, semiconducting chip manufacturing, free-space optical communication, laser surgery and skin treatments, cutting and welding materials, target marking, range and speed measuring, and lighting displays.

### BRIEF DESCRIPTION OF THE SEVERAL VIEWS OF THE DRAWINGS

The present disclosure will be more fully understood by reference to the following figures, which are for illustrative purposes only. The figures are not necessarily drawn to scale, and elements of similar structures or functions are generally represented by like reference numerals for illustrative purposes throughout the figures. The figures do not describe every aspect of the teachings disclosed herein, and do not limit the scope of the claims.

FIG. 1 is a block diagram illustrating an example networked environment for laser power control in accordance with some embodiments of the techniques described herein.

FIG. 2 is a flow diagram depicting an example process for laser power control in accordance with some embodiments of the techniques described herein.

FIG. 3A shows an example demonstrating a non-linear relationship between a laser generating system's power output and duty cycle value.

FIG. 3B shows an example of an estimated correspondence relationship representing a laser generating system's duty cycle value as a polynomial function over its laser power output.

FIG. 4 is a block diagram illustrating elements of an example computing device utilized in accordance with some embodiments of the techniques described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the environment, have not been shown or described in order to avoid unnecessarily obscuring descriptions of the embodiments. Additionally, the various embodiments may be methods, systems, media, or devices. Accordingly, the various embodiments may combine software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

References to the term “set” (e.g., “a set of items”), as used herein, unless otherwise noted or contradicted by context, is to be construed as a nonempty collection comprising one or more members or instances.

References to the term “subset” (e.g., “a subset of the set of items”), as used herein, unless otherwise noted or contradicted by context, is to be construed as a nonempty collection comprising one or more members or instances of a set or plurality of members or instances.

Moreover, the term “subset,” as used herein, refers to a proper subset, which is a collection of one or more members or instances that are collectively smaller in number than the set or plurality of which the subset is drawn. For instance, a subset of a set of ten items will have less than ten items and at least one item.

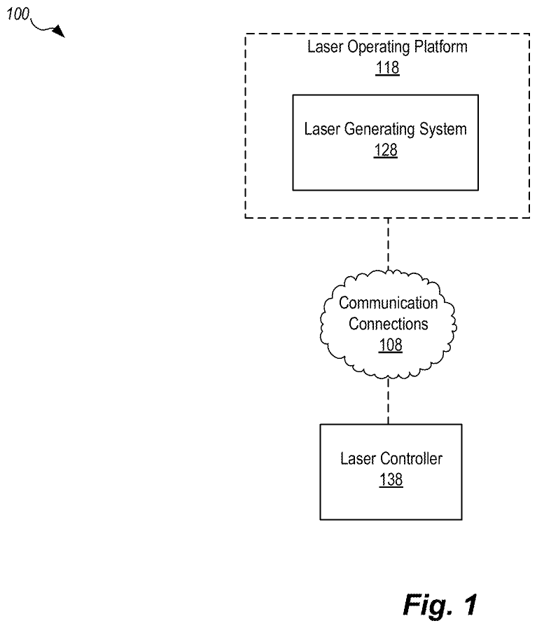

Each of the features and teachings disclosed herein may be utilized separately or in conjunction with other features and disclosure to provide a system and method for achieving laser power control. Representative examples utilizing many of these additional features and teachings, both separately and in combination, are described in further detail with reference to the attached FIGS. 1-4. This detailed description is intended to teach a person of skill in the art further details for practicing aspects of the present disclosure, and is not intended to limit the scope of the claims. Therefore, combinations of features disclosed above in the detailed description may not be necessary to practice the teachings in the broadest sense, and are instead disclosed merely to describe particularly representative examples of the present disclosure.

In the description below, for purposes of explanation only, specific nomenclature is set forth to provide a thorough understanding of the system and method for achieving context awareness by the smart device or smart system. However, it will be apparent to one skilled in the art that these specific details are not required to practice the teachings of the current disclosure. Also, other methods and systems may also be used.

The power output of a laser generating system can be related to one or more input parameters. For example, a CO2 laser is typically controlled using a pulse width modulation (PWM) signal with a base frequency of at least 5 KHz. Radio frequency (RF) excitation for the laser can be switched on and off by the PWM signal at a set frequency but with variable pulse width to control the average intensity or power of the light emitted from the laser. A duty cycle is the fraction of one period (e.g., a full on-off cycle) when the laser is switched on, and is typically expressed as a ratio or percentage.

The relationship between duty cycle and laser power can be a curve or otherwise non-linear, depending on the type and characteristic of the laser generating system. Additionally, laser power can degrade with use over time, in a manner related to the type and characteristic of the laser generating system. Traditionally, laser power is manually adjusted through trial and error (e.g., the end user adjusts the duty cycle directly assuming a linear relationship between the duty cycle and laser power) while the laser is operated continuously. This type of control is wasteful, time consuming, inaccurate, and impractical for many laser generating systems. In particular, there is a need for efficient and suitable mechanisms for laser power control in laser-based stitching, sealing, or other non-continuous operations over discrete objects (e.g., plastic bags, cans, or other containers).

As stated above, the relationship between input parameter(s) and laser power output can be non-linear, for example, an adjustment of 5% at the low end of the scale of the duty cycle can be very different from an adjustment of 5% at the high end of the scale. Also because the power output degrades over time, a 30% duty cycle signal, for example, may provide satisfactory performance on a new laser system, but to achieve the same level of laser output after much usage of the system, a 45% signal may be needed. Further, if one laser operating platform has a particular model of laser installed, the signal requirement can be entirely different from others with different models of laser. For example, a facility may have a 30 Watt rated laser installed on some production lines, and a 40 Watt rated laser installed on other production lines. The power relationships for these different systems can be quite different.

The present disclosure relates generally to laser power control, and more specifically to CO2 laser output control for laser-based stitching, sealing, or other non-continuous operations. Illustratively in accordance with an example implementation, an end user can specify the desired laser power output (e.g., in Watts) via a user interface, and the associated laser power control can calculate corresponding input parameter(s) (e.g., the duty cycle value) needed control the laser generating system and achieve that level of laser power.

In various embodiments, the techniques described herein include a method for controlling power output of a CO2 laser generating system. The method includes obtaining data regarding laser output and input applicable to the CO2 laser generating system, and using the obtained data to generate an estimated correspondence relationship between at least one input parameter and the power output of the CO2 laser generating system. The method also includes, responsive to an indication of a target power output of laser, configuring the at least one input parameter to control the CO2 laser generating system in accordance with the estimated correspondence relationship, thereby causing a resultant laser output, and obtaining updated data regarding the laser output and input applicable to the CO2 laser generating system. The method further includes determining whether to update the estimated correspondence relationship based, at least in part, on the updated data.

In some embodiments, obtaining the data regarding laser output and input applicable to the CO2 laser generating system comprises obtaining data of a plurality of duty cycle values and their corresponding laser power outputs.

In some embodiments, using the obtained data to generate an estimated correspondence relationship comprises performing at least one of curve fitting, interpolation, or non-linear regression.

In some embodiments, the estimated correspondence relationship is a polynomial function. In some embodiments, configuring the at least one input parameter to control the CO2 laser generating system in accordance with the estimated correspondence relationship comprises calculating and setting a duty cycle of the CO2 laser generating system based on the polynomial function evaluated at the value of the target power output.

In some embodiments, obtaining the updated data regarding the laser output and input applicable to the CO2 laser generating system is performed, at least in part, by the CO2 laser generating system between functional operations.

In some embodiments, determining whether to update the estimated correspondence relationship comprises computing a deviation from the estimated correspondence relationship using the updated data.

FIG. 1 is a block diagram illustrating an example networked environment 100 for laser power control in accordance with some embodiments of the techniques described herein. The networked environment 100 includes a laser operating platform 118, one or more laser generating systems 128, and a laser controller 138. The laser controller 138 and the laser operating platform 118 are connected via at least some part of communication connections 108.

In the depicted networked environment 100, the communication connections 108 may comprise one or more computer networks, one or more wired or wireless networks, satellite transmission media, one or more cellular networks, digital or analog signaling, or some combination thereof. The communication connections 108 may include a publicly accessible network of linked networks, possibly operated by various distinct parties, such as the Internet. The communication connections 108 may include other network types, such as one or more private networks (e.g., corporate or university networks that are wholly or partially inaccessible to non-privileged users), and may include combinations thereof, such that (for example) one or more of the private networks have access to and/or from one or more of the public networks. Furthermore, the communication connections 108 may include various types of wired and/or wireless connection in various situations, including satellite transmission. In addition, the communication connections 108 may include one or more communication interfaces to individual entities in the networked environment 100, various other mobile devices, computing devices and media devices, including but not limited to, radio frequency (RF) transceivers, cellular communication interfaces and antennas, USB interfaces, ports and connections (e.g., USB Type-A, USB Type-B, USB Type-C (or USB-C), USB mini A, USB mini B, USB micro A, USB micro C), other RF transceivers (e.g., infrared transceivers, Zigbee® network connection interfaces based on the IEEE 802.15.4 specification, Z-Wave® connection interfaces, wireless Ethernet (“Wi-Fi”) interfaces, short range wireless (e.g., Bluetooth®) interfaces and the like.

In various embodiments, the laser controller 138 can include one or more computing devices for facilitating and performing laser power control functions described herein. The laser controller 138 can include functional units for detecting or assessing laser power output, estimating or otherwise determining relationships between input parameter(s) and laser output, input parameter setting or other control to achieve desired laser output, combinations of the same or the like. The laser controller 138 can be implemented in software and/or hardware form on one or more computing devices including a “computer,” “mobile device,” “tablet computer,” “smart phone,” “handheld computer,” and/or “workstation,” etc. In some embodiments, the laser controller 138 or one or more of its components is part of the laser operating platform 118 or part of the laser generating system 128.

Data communications among entities of the networked environment 100 can be encrypted. Related encryption and decryption may be performed as applicable according to one or more of any number of currently available or subsequently developed encryption methods, processes, standards, protocols, and/or algorithms, including but not limited to: encryption processes utilizing a public-key infrastructure (PKI), encryption processes utilizing digital certificates, the Data Encryption Standard (DES), the Advanced Encryption Standard (AES 128, AES 192, AES 256, etc.), the Common Scrambling Algorithm (CSA), encryption algorithms supporting Transport Layer Security 1.0, 1.1, and/or 1.2, encryption algorithms supporting the Extended Validation (EV) Certificate, etc.

The laser operating platform 118 can include production lines, machines, devices, or other physical structure configured to make functional use of laser, e.g., in optical disc drives, laser printers, barcode scanners, DNA sequencing instruments, fiber-optic, semiconducting chip manufacturing, free-space optical communication, laser surgery and skin treatments, cutting and welding materials, target marking, range and speed measuring, or lighting displays. In particular, the laser operating platform 118 can use laser to mark, fuse, seal, or otherwise manipulate discrete objects (e.g., a laser stitching system that automatically stitches bags or other enclosures).

The laser operating platform 118 can include, control, or otherwise be associated with the laser generating system(s) 128. The laser generating system(s) 128 can include systems or devices that generate one or more types of laser using the same or different operating principles, e.g., gas lasers, chemical lasers, excimer lasers, solid-state lasers, fiber lasers, photonic crystal lasers, semiconductor lasers, dye lasers, free-election lasers, or the like. In particular, the laser generating system 128 can be a CO2 laser generating system, e.g., with a maximum laser power output between 0 and 200 Watts.

The above description of the exemplary networked environment 100 and the various service providers, systems, networks, and devices therein is intended as a broad, non-limiting overview of an exemplary environment in which various embodiments of the facility may be implemented. FIG. 1 illustrates just one example of an operating environment, and the various embodiments discussed herein are not limited to such environments. In particular, the networked environment 100 may contain other devices, systems and/or media not specifically described herein.

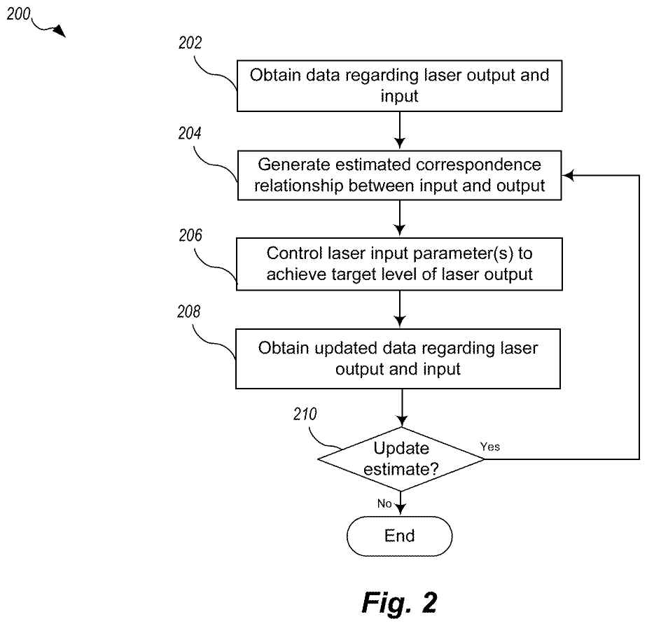

FIG. 2 is a flow diagram depicting an example process 200 for laser power control in accordance with some embodiments of the techniques described herein. Illustratively, at least some part of the process 200 can be implemented by the laser controller 138 of FIG. 1.

The process 200 starts at block 202, which includes obtaining data regarding laser power output and input parameter(s) or attribute(s) for a laser generating system 128, e.g., a CO2 laser. The data can include readings from sensor(s) (e.g., thermopile sensors for measuring pulsed or continuous wave lasers) that measure laser power output, as well as the values of input parameter(s) or attribute(s) that cause or otherwise correspond to the measured laser power output. The data can be collected from the laser generating system 128 itself, or from another laser generating system of the same type or model.

The data can be obtained in accordance with a set of evenly or unevenly distributed input parameter values. For example, at various duty cycles (evenly distributed from 10% to 100%, at 10% increments), the minimum, maximum, and mean values of laser power output for each duty cycle over a 5-minute period can be collected. Adequate time can be allowed for the laser generating system to cool down between the observations. The table below shows laser power measurements from a 30-Watt CO2 laser generating system in comparison with linear reference values:

| Duty | Min | Mean | Max | Linear |
|---|---|---|---|---|
| Cycle | Watts | Watts | Watts | Reference |
| 10 | 5.927 | 6.057 | 6.176 | 4.5 |
| 20 | 13.2 | 13.48 | 13.81 | 9 |
| 30 | 19.26 | 19.68 | 20.08 | 13.5 |
| 40 | 24.33 | 24.92 | 25.65 | 18 |
| 50 | 28.58 | 29.29 | 29.96 | 22.5 |
| 60 | 32.08 | 32.97 | 33.8 | 27 |
| 70 | 34.87 | 36.18 | 37.4 | 31.5 |
| 80 | 37.36 | 38.65 | 40.26 | 36 |
| 90 | 39.45 | 40.61 | 42.11 | 40.5 |
| 100 | 40.68 | 42.07 | 43.76 | 45 |

At block 204, the process 200 includes generating an estimated correspondence relationship between input parameter(s) and laser power output based on the data obtained at block 202. Curve fitting, interpolation, extrapolation, non-linear regression, or other applicable methods can be used. The correspondence relationship can be a function, mapping table, probabilistic model, or the like.

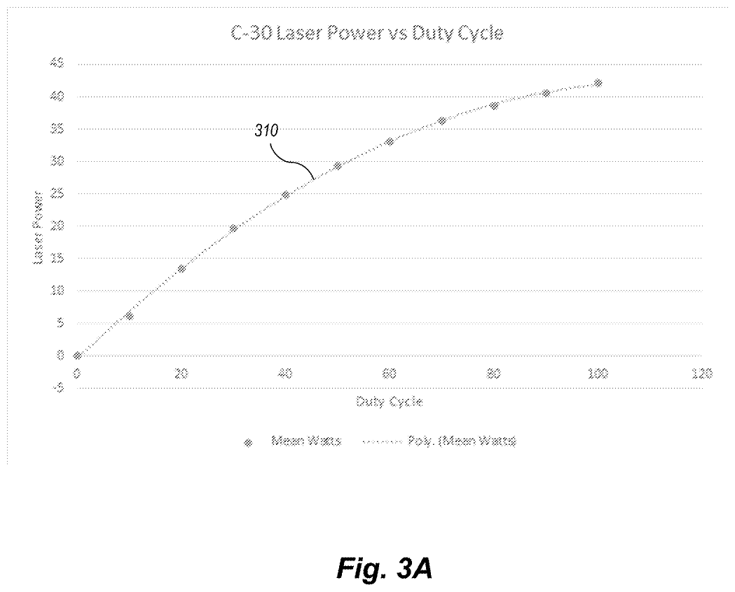

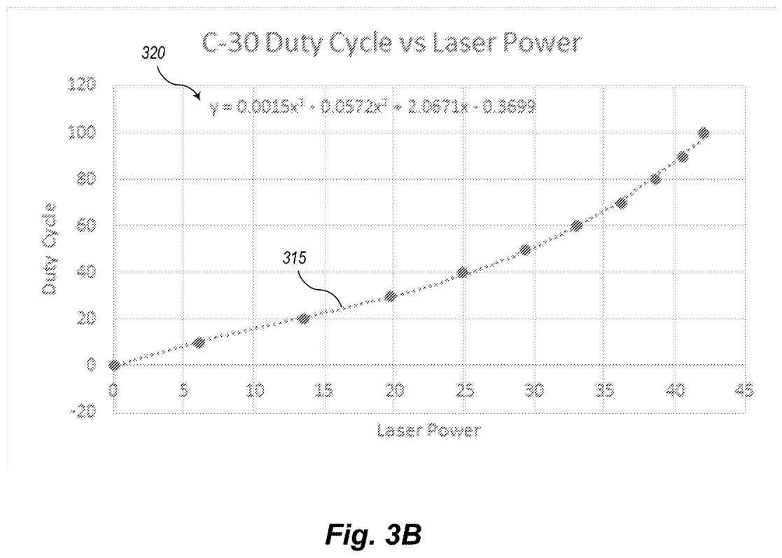

FIG. 3A shows an example demonstrating a non-linear relationship 310 between a 30-Watt CO2 laser generating system's power output and duty cycle value. The relationship can be determined based on the table of values shown above. To calculate the value of input parameter(s) (e.g., duty cycle) for a target power output, a relationship inverse of the relationship 310 is estimated or otherwise determined.

FIG. 3B shows an example of the estimated correspondence relationship 315. In particular, the estimated correspondence relationship 315 represents the 30-Watt CO2 laser's duty cycle value as a polynomial function 320 over its laser power output. This polynomial function 320 can also be estimated based on the table of values shown above.

At block 206, the process 200 includes controlling laser input parameter(s) to achieve a target level of laser output. Applying the estimated correspondence relationship, corresponding input parameter value can be determined for a target laser power output value. Using the estimated polynomial function 320 as an example, the laser controller 138 can calculate and set a duty cycle of the CO2 laser generating system by evaluating the polynomial function with the value of the target power output.

In some embodiments, the target power output is different between operations or objects, which leads to different values of input parameter(s). For example, the target power output can be different for laser marking or stitches at different positions, over different objects, or at different times. Illustratively, the target power output can itself be a function or pattern based on factors including object type, time, position, purpose, or the like. The estimated correspondence relationship can be applied efficiently, repeated, and quickly, in response to changing values of target power output that are desired, to provide proper and applicable input parameter(s) that controls the laser generating system to generate resultant laser outputs. In some embodiments, the target power output or factors thereof can be specified by a user via a user interface, prior to the determination of proper input parameter(s).

At block 208, the process 200 includes obtaining updated data regarding laser input parameter(s) and power output. In some embodiments, obtaining the updated data is performed periodically. For example, the actual usage time of the laser generating system is tracked, and when the total accumulated usage has reached a threshold level (e.g., 1,000 hours), manual or automatic collection of updated data can be performed. This can be achieved a manner similar to block 202.

In some embodiments, obtaining the updated data is performed concurrently with or between functional operations of the laser generating system (e.g., concurrently with or between laser markings, laser stitches, or objects). The distribution of input parameter(s) may or may not match those obtained in block 202, and can be determined by the operating status of the laser operating platform 118 at the time.

At block 208, the process 200 includes determining whether the estimated correspondence relationship needs to be updated. In some embodiments, a deviation from the estimated correspondence relationship is calculated using the updated data. The deviation can be a difference between a target laser power output and a corresponding observed laser power output resulted from input parameter(s) that is determined based on the target laser power output. The deviation can be a set of such differences, or a fluctuation of laser outputs.

If the deviation exceeds a threshold, the laser controller 138 can determine that the estimated correspondence relationship needs to be updated, and the process 200 proceeds back to block 204, where a new estimated correspondence relationship between input parameter(s) and laser power output is generated based on the updated data. The new estimated correspondence relationship can maintain the same or similar shape (e.g., being proportional to) as the previously estimated correspondence relationship, or can have a different shape. The method (e.g., curve fitting, interpolation, extrapolation, non-linear regression, or the like) for generating the new estimated correspondence relationship may or may not be the same as used in block 204 in the previous round.

Returning to block 208, if the laser controller 138 determines that the estimated correspondence relationship does not need to be updated, the process 200 ends.

Those skilled in the art will appreciate that the various operations depicted via FIG. 2, as well as those described elsewhere herein, may be altered in a variety of ways. For example, the particular order of the operations may be rearranged; some operations may be performed in parallel; shown operations may be omitted, or other operations may be included; a shown operation may be divided into one or more component operations, or multiple shown operations may be combined into a single operation, etc.

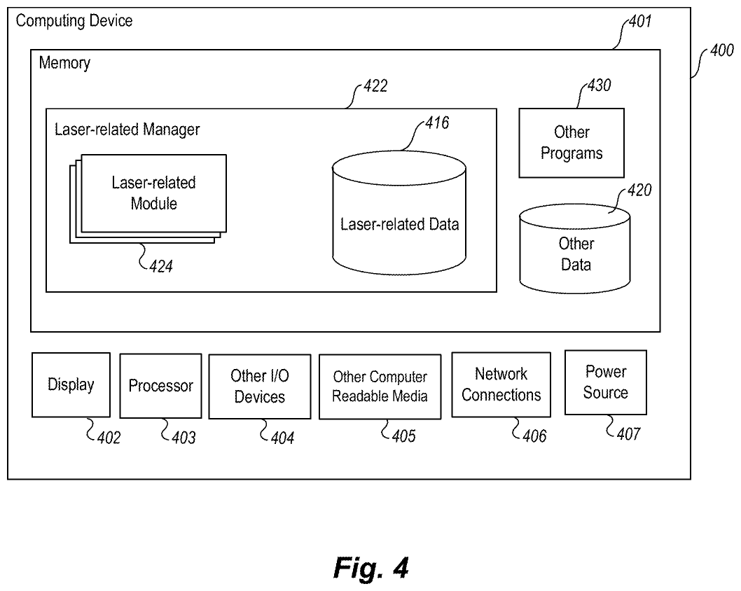

FIG. 4 is a block diagram illustrating elements of an example computing device 400 utilized in accordance with some embodiments of the techniques described herein. Illustratively, the computing device 400 corresponds to a laser controller 138, laser operating platform 118, laser generating system 128, or at least a part thereof.

In some embodiments, one or more general purpose or special purpose computing systems or devices may be used to implement the computing device 400. In addition, in some embodiments, the computing device 400 may comprise one or more distinct computing systems or devices, and may span distributed locations. Furthermore, each block shown in FIG. 4 may represent one or more such blocks as appropriate to a specific embodiment or may be combined with other blocks. Also, the laser-related manager 422 may be implemented in software, hardware, firmware, or in some combination to achieve the capabilities described herein.

As shown, the computing device 400 comprises a computer memory (“memory”) 401, a display 402 (including, but not limited to a light emitting diode (LED) panel, cathode ray tube (CRT) display, liquid crystal display (LCD), touch screen display, projector, etc.), one or more Central Processing Units or other processors 403, Input/Output (“I/O”) devices 404 (e.g., keyboard, mouse, RF or infrared receiver, universal serial bus (USB) ports, High-Definition Multimedia Interface (HDMI) ports, other communication ports, and the like), other computer-readable media 405, network connections 406, a power source (or interface to a power source) 407. The laser-related manager 422 is shown residing in memory 401. In other embodiments, some portion of the contents and some, or all, of the components of the laser-related manager 422 may be stored on and/or transmitted over the other computer-readable media 405. The components of the computing device 400 and laser-related manager 422 can execute on one or more processors 403 and implement applicable functions described herein. In some embodiments, the laser-related manager 422 may operate as, be part of, or work in conjunction and/or cooperation with other software applications stored in memory 401 or on various other computing devices. In some embodiments, the laser-related manager 422 also facilitates communication with peripheral devices via the I/O devices 404, or with another device or system via the network connections 406.

The one or more laser-related modules 424 is configured to perform actions related, directly or indirectly, to laser power control as described herein. In some embodiments, the laser-related module(s) 424 stores, retrieves, or otherwise accesses at least some laser-related data on some portion of the laser-related data storage 416 or other data storage internal or external to the computing device 400. The laser-related modules 424 may control or comprise interfaces for managing or controlling laser power as described herein. In various embodiments, at least some of the laser-related modules 424 may be implemented in software or hardware.

Other code or programs 430 (e.g., further data processing modules, a Web server, and the like), and potentially other data repositories, such as data repository 420 for storing other data, may also reside in the memory 401, and can execute on one or more processors 403. Of note, one or more of the components in FIG. 4 may or may not be present in any specific implementation. For example, some embodiments may not provide other computer readable media 405 or a display 402.

In some embodiments, the computing device 400 and laser-related manager 422 include API(s) that provides programmatic access to add, remove, or change one or more functions of the computing device 400. In some embodiments, components/modules of the computing device 400 and laser-related manager 422 are implemented using standard programming techniques. For example, the laser-related manager 222 may be implemented as an executable running on the processor 403, along with one or more static or dynamic libraries. In other embodiments, the computing device 400 and laser-related manager 422 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware implementation, instructions stored in a memory configure, when executed, one or more processors of the computing device 400 to perform the functions of the laser-related manager 422. In some embodiments, instructions cause the processor 403 or some other processor, such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously, and communicate using message passing techniques. Equivalent synchronous embodiments are also supported by a laser-related manager 422 implementation. Also, other functions could be implemented and/or performed by each component/module, and in different orders, and by different components/modules, yet still achieve the functions of the computing device 400 and laser-related manager 422.

In addition, programming interfaces to the data stored as part of the computing device 400 and laser-related manager 422, can be available by standard mechanisms such as through C, C++, C#, and Java APIs; libraries for accessing files, databases, or other data repositories; scripting languages such as XML; or Web servers, FTP servers, NFS file servers, or other types of servers providing access to stored data. The laser-related data storage 416 and data repository 420 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the laser-related manager 422.

Furthermore, in some embodiments, some or all of the components of the computing device 400 and laser-related manager 422 may be implemented or provided in other manners, such as at least partially in firmware and/or hardware, including, but not limited to one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use, or provide the contents to perform, at least some of the described techniques.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. In cases where the present patent application conflicts with an application or other document incorporated herein by reference, the present application controls. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for controlling power output of a CO2 laser generating system, comprising:
obtaining data regarding laser output and input applicable to the CO2 laser generating system;
using the obtained data to generate an estimated correspondence relationship between at least one input parameter and the power output of the CO2 laser generating system;
responsive to an indication of a target power output of laser, configuring the at least one input parameter to control the CO2 laser generating system in accordance with the estimated correspondence relationship, thereby causing a resultant laser output;
obtaining updated data regarding the laser output and input applicable to the CO2 laser generating system; and
determining whether to update the estimated correspondence relationship based, at least in part, on the updated data.

2. The method of claim 1, wherein obtaining the data regarding laser output and input applicable to the CO2 laser generating system comprises obtaining data of a plurality of duty cycle values and their corresponding laser power outputs.

3. The method of claim 1, wherein using the obtained data to generate an estimated correspondence relationship comprises performing at least one of curve fitting, interpolation, or non-linear regression.

4. The method of claim 1, wherein the estimated correspondence relationship is a polynomial function.

5. The method of claim 4, wherein configuring the at least one input parameter to control the CO2 laser generating system in accordance with the estimated correspondence relationship comprises calculating and setting a duty cycle of the CO2 laser generating system based on the polynomial function evaluated with the value of the target power output.

6. The method of claim 1, wherein obtaining the updated data regarding the laser output and input applicable to the CO2 laser generating system is performed, at least in part, by the CO2 laser generating system between functional operations.

7. The method of claim 1, wherein determining whether to update the estimated correspondence relationship comprises computing a deviation from the estimated correspondence relationship using the updated data.

8. One or more non-transitory computer-readable media collectively storing contents that, when executed by one or more processors, cause the one or more processors to perform actions comprising:
obtaining an estimated correspondence relationship between at least one input parameter and power output of a laser generating system;
responsive to an indication of a target power output of laser, configuring the at least one input parameter to control the laser generating system in accordance with the estimated correspondence relationship, thereby causing a resultant laser output;
obtaining updated data regarding laser output and input applicable to the laser generating system; and
determining whether to update the estimated correspondence relationship based, at least in part, on the updated data.

9. The one or more non-transitory computer-readable media of claim 8, wherein the estimated correspondence relationship is generated based, at least in part, on data in accordance with a plurality of duty cycle values.

10. The one or more non-transitory computer-readable media of claim 8, wherein the actions further comprise generating an updated estimated correspondence relationship responsive to a determination to update the estimated correspondence relationship.

11. The one or more non-transitory computer-readable media of claim 10, wherein generating the updated estimated correspondence relationship comprises performing at least one of curve fitting, interpolation, or non-linear regression.

12. The one or more non-transitory computer-readable media of claim 8, wherein the estimated correspondence relationship is a polynomial function.

13. The one or more non-transitory computer-readable media of claim 12, wherein configuring the at least one input parameter to control the laser generating system in accordance with the estimated correspondence relationship comprises calculating and setting a duty cycle of the laser generating system based on the polynomial function evaluated with the value of the target power output.

14. The one or more non-transitory computer-readable media of claim 8, wherein determining whether to update the estimated correspondence relationship comprises computing a deviation from the estimated correspondence relationship using the updated data.

15. A device for controlling laser power, comprising:
one or more processors; and
memory storing contents that, when executed by the one or more processors, cause the device to:
obtain an estimated correspondence relationship between at least one input parameter and power output of a laser generating system;
responsive to an indication of a target power output of laser, configure the at least one input parameter to control the laser generating system in accordance with the estimated correspondence relationship, thereby causing a resultant laser output;
obtain updated data regarding laser output and input applicable to the laser generating system; and
determine whether to update the estimated correspondence relationship based, at least in part, on the updated data.

16. The device of claim 15, wherein the estimated correspondence relationship is generated based, at least in part, on data obtained from another laser generating system.

17. The device of claim 15, wherein the contents further cause the device to generate an updated estimated correspondence relationship responsive to a determination to update the estimated correspondence relationship.

18. The device of claim 17, wherein the updated estimated correspondence relationship has the same shape as the estimated correspondence relationship.

19. The device of claim 15, wherein the estimated correspondence relationship is a polynomial function.

20. The device of claim 19, wherein configuring the at least one input parameter to control the laser generating system in accordance with the estimated correspondence relationship comprises calculating and setting a duty cycle of the laser generating system based on the polynomial function evaluated with the value of the target power output.
